(19) United States
(12) Patent Application Publication
(10) Pub. No.: US 2018/0087907 A1
(43) Pub. Date: Mar. 29, 2018

(54) AUTONOMOUS VEHICLE: VEHICLE LOCALIZATION

(71) Applicants: The Charles Stark Draper Laboratory, Inc., Cambridge, MA (US); AutoLIV ASP, Inc., Southfield, MI (US)

(72) Inventors: Paul DeBitetto, Concord, MA (US); Matthew Graham, Arlington, MA (US); Troy Jones, Somerville, MA (US); Peter Lommel, Andover, MA (US); Jon Demerly, Byron, MI (US)

(21) Appl. No.: 15/280,296

(22) Filed: Sep. 29, 2016

(51) Int. Cl. G01C 21/20; G05D 1/00; G05D 1/02; G01C 21/16; G01S 19/42

(52) U.S. Cl. CPC G01C 21/20; G05D 1/0088; G01S 19/42; G01C 21/16; G05D 1/0257

(57) ABSTRACT

In an embodiment, a localization module can provide coordinates of the vehicle relative to the Earth and relative to the drivable surface, both of which are precise enough to allow for self-driving, and further can compensate for a temporary lapse in reliable GPS service by continuing to track the car's position by tracking its movement with inertial sensors (e.g., accelerometers and gyroscopes) and RADAR data. The localization module bases its output on a geolocation relative to the Earth and sensor measurements of the drivable surface and its surroundings to determine where the car is in relation to the Earth and the drivable surface.

### RELATED APPLICATIONS

This application is related to “Autonomous Vehicle: Object-Level Fusion” by Matthew Graham, Kyra Horne, Troy Jones, Paul DeBitetto, and Scott Lennox, Attorney Docket No. 5000.1005-000 (CSDL-2488), and “Autonomous Vehicle: Modular Architecture” by Troy Jones, Scott Lennox, John Sgueglia, and Jon Demerly, Attorney Docket No. 5000.1007-000 (CSDL-2490), all co-filed on Sep. 29, 2016.

The entire teachings of the above applications are incorporated herein by reference.

### BACKGROUND

Currently, vehicles can employ automated systems such as lane assist, pre-collision breaking, and rear cross-track detection. These systems can assist a driver of the vehicle from making human error and to avoid crashes with other vehicles, moving objects, or pedestrians. However, these systems only automate certain vehicle functions, and still rely on the driver of the vehicle for other operations.

### SUMMARY

In an embodiment, a method of navigating an autonomous vehicle includes correlating a global positioning system (GPS) signal received at an autonomous vehicle with a position on a map loaded from a database. The method further includes determining, from a list of features received from a RADAR sensor of the autonomous vehicle over a plurality of time steps relative to the autonomous vehicle, a location of the autonomous vehicle relative to the drivable surface. The method further includes providing an improved location of the autonomous vehicle based on the location of the autonomous vehicle relative to the drivable surface and the GPS signal by correlating the location of the autonomous vehicle relative to the drivable surface to lane data and drivable surface width from a map. The GPS signal can output geodetic data, however, in other embodiments other systems can output geodetic data.

In an embodiment, the method further includes determining, from the list of features, an attitude of the autonomous vehicle relative to the drivable surface.

In an embodiment, the method further includes matching image data received by a vision sensor of the autonomous vehicle to landmark features stored in a database.

In an embodiment, the method further includes tracking relative position of each feature from a given sensor across multiple time steps and retaining features determined to be stationary based on the tracked relative position. The method can further include, for radar features, performing an Extended Kalman Filter (EKF) measurement to update vehicle position and attitude, and updating error estimates and quality metrics for input sensor sources, each time a radar feature is observed. The method can also include, for vision features, tracking each vision feature until each vision feature leaves a sensor field of view, adding clone states each time the feature is observed, and upon the vision feature leaving a field-of-view of the sensor, performing a Multi-State-Constrained-Kalman-Filter (MSCKF) filter measurement update to update vehicle position and attitude, and update error estimates and quality metrics for input sensor sources. Retaining features can include employing both radar features tracks and vision feature tracks, and determining stationary features based on a comparison of predicted autonomous vehicle motion to the feature tracks.

In an embodiment, the RADAR sensor outputs RADAR features and multi-target tracking data.

In an embodiment, the method includes converting the list of features to a list of relative positions of objects relative to the position of the autonomous vehicle.

In an embodiment, the method also includes the features being vision features, and further converting the vision features to lines of sight relative to the autonomous vehicle.

In an embodiment, the method includes providing an improved location further includes employing inertial measurement unit (IMU) data.

In an embodiment, a system for navigating an autonomous vehicle, includes a correlation module configured to correlate a global positioning system (GPS) signal received at an autonomous vehicle with a position on a map loaded from a database. The system further includes an localization controller configured to determine, from a list of features received from a RADAR sensor of the autonomous vehicle over a plurality of time steps relative to the autonomous vehicle, a location of the autonomous vehicle relative to stationary features in the environment, and provide an improved location of the autonomous vehicle based on the location of the autonomous vehicle relative to the drivable surface and the GPS signal by correlating the location of the autonomous vehicle relative to the drivable surface to lane data and drivable surface width from a map.

In an embodiment, a method of navigating an autonomous vehicle includes determining a last accurate global positioning system (GPS) signal received at an autonomous vehicle. The method further includes determining a trajectory of the autonomous vehicle based on data from an inertial measurement unit (IMU) of the autonomous vehicle and RADAR data including a list of stationary features over a plurality of time steps relative to the autonomous vehicle. The list of stationary features have a distance and angle of each stationary feature relative to the autonomous vehicle. The method further includes calculating a new position of the autonomous vehicle by combining the last accurate GPS signal with the trajectory.

In an embodiment, a system for navigating an autonomous vehicle, includes a GPS receiver of an autonomous vehicle, and a localization controller. The localization controller is configured to determine a last accurate global positioning system (GPS) signal received at the GPS receiver of the autonomous vehicle. The localization controller is further configured to determine a trajectory of the autonomous vehicle based on data from an inertial measurement unit (IMU) of the autonomous vehicle and RADAR data including a list of stationary features over a plurality of time steps relative to the autonomous vehicle. The list of stationary features has a distance and angle of each stationary feature relative to the autonomous vehicle. The localization controller is further configured to calculate a new position of the autonomous vehicle by combining the last accurate GPS signal with the trajectory.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram illustrating steps in an embodiment of an automated control system of the Observe, Orient, Decide, and Act (OODA) model.

FIG. 2 is a block diagram of an embodiment of an autonomous vehicle high-level architecture.

FIG. 3 is a block diagram illustrating an embodiment of the sensor interaction controller (SIC), perception controller (PC), and localization controller (LC).

FIG. 4 is a block diagram illustrating an example embodiment of the automatic driving controller (ADC), vehicle controller (VC) and actuator controller.

FIG. 5 is a diagram illustrating decision time scales of the ADC and VC.

FIG. 6 is a block diagram illustrating an example embodiment of the system controller, human interface controller (HC) and machine interface controller (MC).

FIGS. 7A-B are diagrams illustrating an embodiment of the present invention in a real-world environment.

FIG. 8 is a flow diagram illustrating an example embodiment of a process employed by the present invention.

FIG. 9 is a flow diagram illustrating an example embodiment of a process employed by the present invention.

FIG. 10 illustrates a computer network or similar digital processing environment in which embodiments of the present invention may be implemented.

FIG. 11 is a diagram of an example internal structure of a computer (e.g., client processor/device or server computers) in the computer system of FIG. 10.

### DETAILED DESCRIPTION

A description of example embodiments of the invention follows.

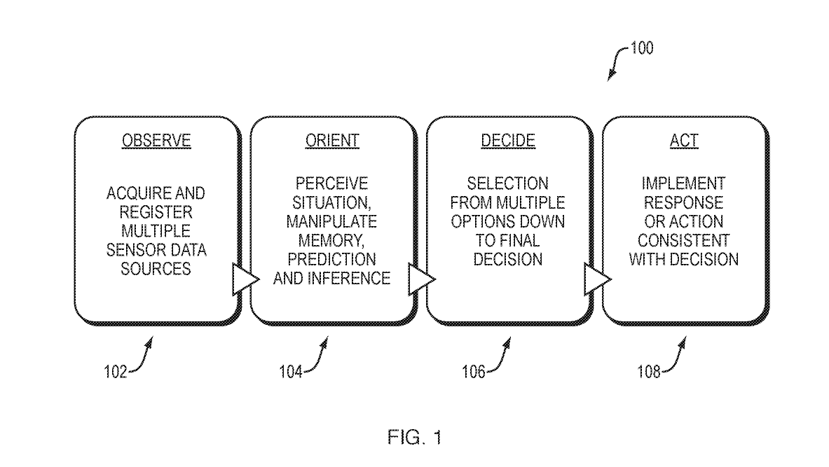

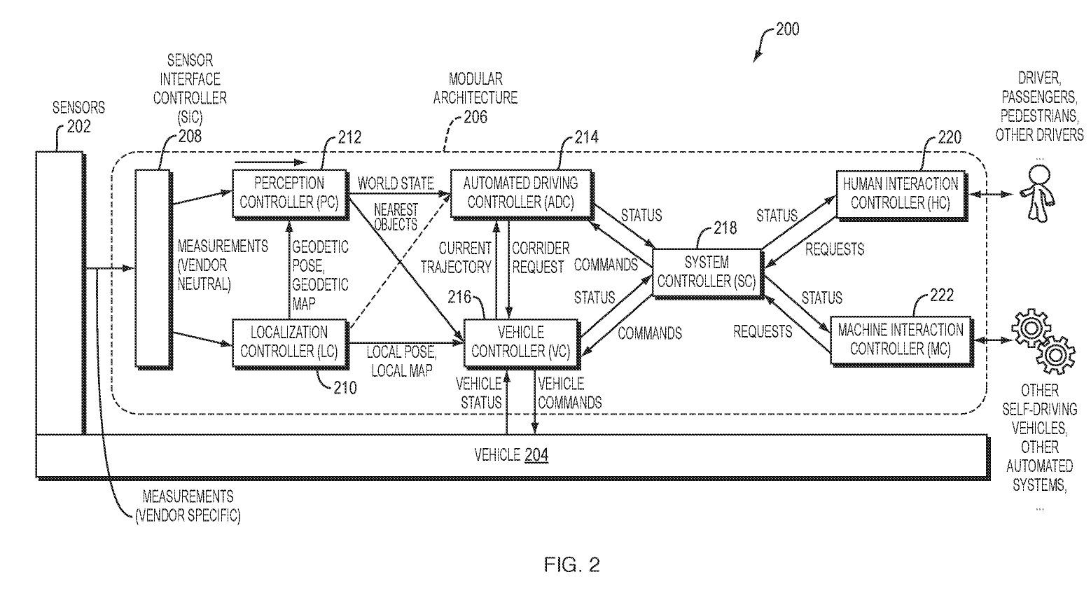

FIG. 1 is a diagram illustrating steps in an embodiment of an automated control system of the Observe, Orient, Decide, and Act (OODA) model. Automated systems, such as highly-automated driving systems, or, self-driving cars, or autonomous vehicles, employ an OODA model. The observe virtual layer 102 involves sensing features from the world using machine sensors, such as laser ranging, radar, infra-red, vision systems, or other systems. The orientation virtual layer 104 involves perceiving situational awareness based on the sensed information. Examples of orientation virtual layer activities are Kalman filtering, model based matching, machine or deep learning, and Bayesian predictions. The decide virtual layer 106 selects an action from multiple objects to a final decision. The act virtual layer 108 provides guidance and control for executing the decision. FIG. 2 is a block diagram 200 of an embodiment of an autonomous vehicle high-level architecture 206. The architecture 206 is built using a top-down approach to enable fully automated driving. Further, the architecture 206 is preferably modular such that it can be adaptable with hardware from different vehicle manufacturers. The architecture 206, therefore, has several modular elements functionally divided to maximize these properties. In an embodiment, the modular architecture 206 described herein can interface with sensor systems 202 of any vehicle 204. Further, the modular architecture 206 can receive vehicle information from and communicate with any vehicle 204.

Elements of the modular architecture 206 include sensors 202, Sensor Interface Controller (SIC) 208, localization controller (LC) 210, perception controller (PC) 212, automated driving controller 214 (ADC), vehicle controller 216 (VC), system controller 218 (SC), human interaction controller 220 (HC) and machine interaction controller 222 (MC).

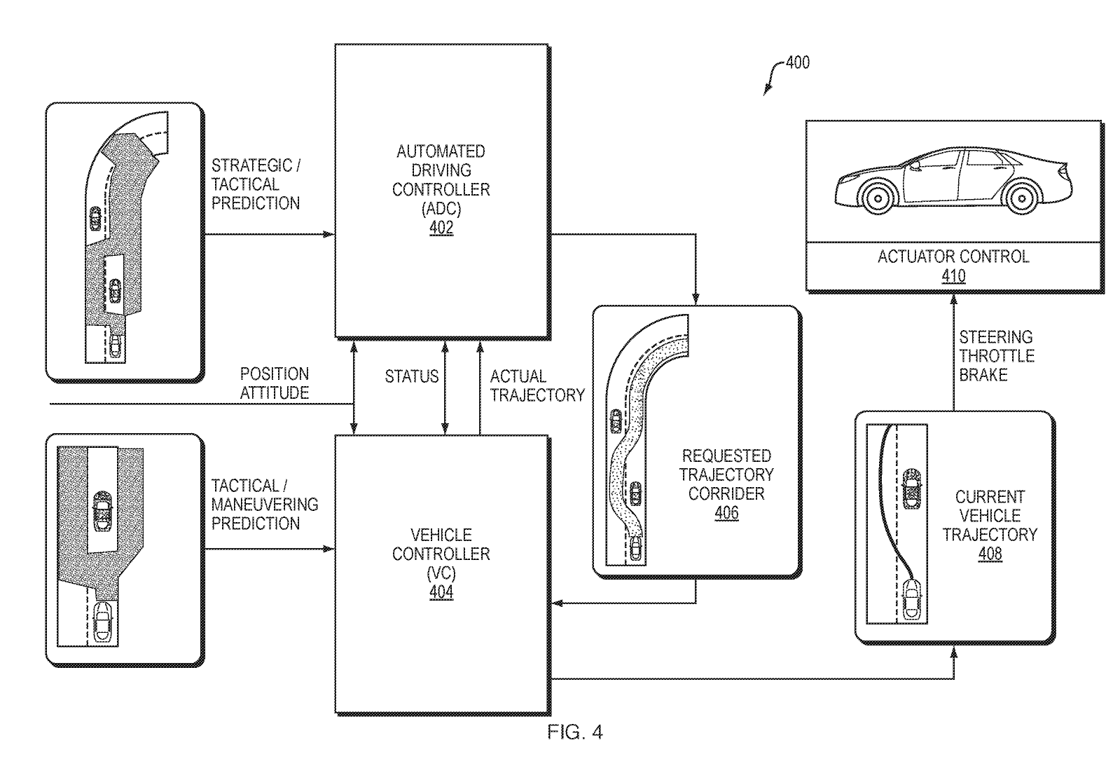

Referring again to the OODA model of FIG. 1, in terms of an autonomous vehicle, the observation layer of the model includes gathering sensor readings, for example, from vision sensors, Radar (Radio Detection And Ranging), LIDAR (Light Detection And Ranging), and Global Positioning Systems (GPS). The sensors 202 shown in FIG. 2 shows such an observation layer. Examples of the orientation layer of the model can include determining where a car is relative to the world, relative to the road it is driving on, and relative to lane markings on the road, shown by Perception Controller (PC) 212 and Localization Controller (LC) 210 of FIG. 2. Examples of the decision layer of the model include determining a corridor to automatically drive the car, and include elements such as the Automatic Driving Controller (ADC) 214 and Vehicle Controller (VC) 216 of FIG. 2. Examples of the act layer include converting that corridor into commands to the vehicle's driving systems (e.g., steering sub-system, acceleration sub-system, and breaking sub-system) that direct the car along the corridor, such as actuator control 410 of FIG. 4. A person of ordinary skill in the art can recognize that the layers of the system are not strictly sequential, and as observations change, so do the results of the other layers. For example, after the system chooses a corridor to drive in, changing conditions on the road, such as detection of another object, may direct the car to modify its corridor, or enact emergency procedures to prevent a collision. Further, the commands of the vehicle controller may need to be adjusted dynamically to compensate for drift, skidding, or other changes to expected vehicle behavior.

At a high level, the module architecture 206 receives measurements from sensors 202. While different sensors may output different sets of information in different formats, the modular architecture 206 includes Sensor Interface Controller (SIC) 208, sometimes also referred to as a Sensor Interface Server (SIS), configured to translate the sensor data into data having a vendor-neutral format that can be read by the modular architecture 206. Therefore, the modular architecture 206 learns about the environment around the vehicle 204 from the vehicle's sensors, no matter the vendor, manufacturer, or configuration of the sensors. The SIS 208 can further tag each sensor's data with a metadata tag having its location and orientation in the car, which can be used by the perception controller to determine the unique angle, perspective, and blind spot of each sensor.

Further, the modular architecture 206 includes vehicle controller 216 (VC). The VC 216 is configured to send commands to the vehicle and receive status messages from the vehicle. The vehicle controller 216 receives status messages from the vehicle 204 indicating the vehicle's status, such as information regarding the vehicle's speed, attitude, steering position, braking status, and fuel level, or any other information about the vehicle's subsystems that is relevant for autonomous driving. The modular architecture 206, based on the information from the vehicle 204 and the sensors 202, therefore can calculate commands to send from the VC 216 to the vehicle 204 to implement self-driving. The functions of the various modules within the modular architecture 206 are described in further detail below. However, when viewing the modular architecture 206 at a high level, it receives (a) sensor information from the sensors 202 and (b) vehicle status information from the vehicle 204, and in turn, provides the vehicle instructions to the vehicle 204. Such an architecture allows the modular architecture to be employed for any vehicle with any sensor configuration. Therefore, any vehicle platform that includes a sensor subsystem (e.g., sensors 202) and an actuation subsystem having the ability to provide vehicle status and accept driving commands (e.g., actuator control 410 of FIG. 4) can integrate with the modular architecture 206.

Within the modular architecture 206, various modules work together to implement automated driving according to the OODA model. The sensors 202 and SIC 208 reside in the “observe” virtual layer. As described above, the SIC 208 receives measurements (e.g., sensor data) having various formats. The SIC 208 is configured to convert vendor-specific data directly from the sensors to vendor-neutral data. In this way, the set of sensors 202 can include any brand of Radar, LIDAR, image sensor, or other sensors, and the modular architecture 206 can use their perceptions of the environment effectively.

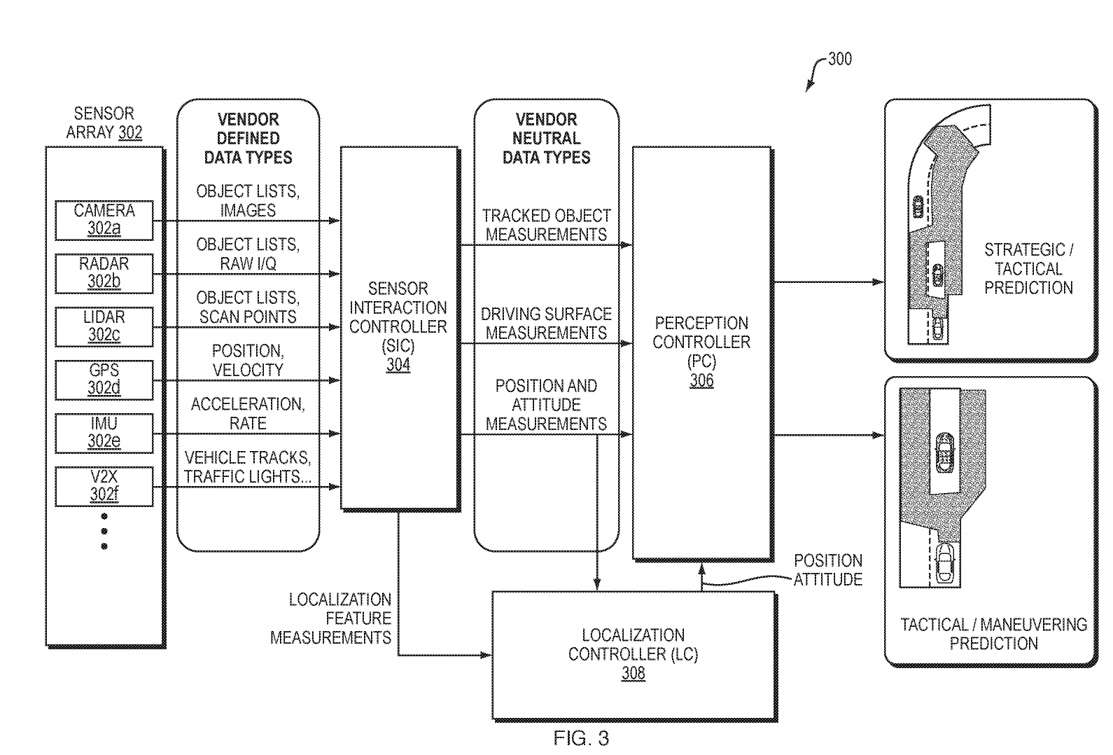

The measurements output by the sensor interface server are then processed by perception controller (PC) 212 and localization controller (LC) 210. The PC 212 and LC 210 both reside in the “orient” virtual layer of the OODA model. The LC 210 determines a robust world-location of the vehicle that can be more precise than a GPS signal, and still determines the world-location of the vehicle when there is no available or an inaccurate GPS signal. The LC 210 determines the location based on GPS data and sensor data. The PC 212, on the other hand, generates prediction models representing a state of the environment around the car, including objects around the car and state of the road. FIG. 3 provides further details regarding the SIC 208, LC 210 and PC 212.

Automated driving controller 214 (ADC) and vehicle controller 216 (VC) receive the outputs of the perception controller and localization controller. The ADC 214 and VC 216 reside in the “decide” virtual layer of the OODA model. The ADC 214 is responsible for destination selection, route and lane guidance, and high-level traffic surveillance. The ADC 214 further is responsible for lane selection within the route, and identification of safe harbor areas to diver the vehicle in case of an emergency. In other words, the ADC 214 selects a route to reach the destination, and a corridor within the route to direct the vehicle. The ADC 214 passes this corridor onto the VC 216. Given the corridor, the VC 216 provides a trajectory and lower level driving functions to direct the vehicle through the corridor safely. The VC 216 first determines the best trajectory to maneuver through the corridor while providing comfort to the driver, an ability to reach safe harbor, emergency maneuverability, and ability to follow the vehicle's current trajectory. In emergency situations, the VC 216 overrides the corridor provided by the ADC 214 and immediately guides the car into a safe harbor corridor, returning to the corridor provided by the ADC 214 when it is safe to do so. The VC 216, after determining how to maneuver the vehicle, including safety maneuvers, then provides actuation commands to the vehicle 204, which executes the commands in its steering, throttle, and braking subsystems. This element of the VC 216 is therefore in the “act” virtual layer of the OODA model. FIG. 4 describes the ADC 214 and VC 216 in further detail.

The modular architecture 206 further coordinates communication with various modules through system controller 218 (SC). By exchanging messages with the ADC 214 and VC 216, the SC 218 enables operation of human interaction controller 220 (HC) and machine interaction controller 222 (MC). The HC 220 provides information about the autonomous vehicle's operation in a human understandable format based on status messages coordinated by the system controller. The HC 220 further allows for human input to be factored into the car's decisions. For example, the HC 220 enables the operator of the vehicle to enter or modify the destination or route of the vehicle, as one example. The SC 218 interprets the operator's input and relays the information to the VC 216 or ADC 214 as necessary.

Further, the MC 222 can coordinate messages with other machines or vehicles. For example, other vehicles can electronically and wirelessly transmit route intentions, intended corridors of travel, and sensed objects that may be in other vehicle's blind spot to autonomous vehicles, and the MC 222 can receive such information, and relay it to the VC 216 and ADC 214 via the SC 218. In addition, the MC 222 can send information to other vehicles wirelessly. In the example of a turn signal, the MC 222 can receive a notification that the vehicle intends to turn. The MC 222 receives this information via the VC 216 sending a status message to the SC 218, which relays the status to the MC 222. However, other examples of machine communication can also be implemented. For example, other vehicle sensor information or stationary sensors can wirelessly send data to the autonomous vehicle, giving the vehicle a more robust view of the environment. Other machines may be able to transmit information about objects in the vehicles blind spot, for example. In further examples, other vehicles can send their vehicle track. In an even further examples, traffic lights can send a digital signal of their status to aid in the case where the traffic light is not visible to the vehicle. A person of ordinary skill in the art can recognize that any information employed by the autonomous vehicle can also be transmitted to or received from other vehicles to aid in autonomous driving. FIG. 6 shows the HC 220, MC 222, and SC 218 in further detail.

FIG. 3 is a block diagram 300 illustrating an embodiment of the sensor interaction controller 304 (SIC), perception controller (PC) 306, and localization controller (LC) 308. A sensor array 302 of the vehicle can include various types of sensors, such as a camera 302a, radar 302b, LIDAR 302c, GPS 302d, IMU 302e, or vehicle-to-everything (V2X) 302f. Each sensor sends individual vendor defined data types to the SIC 304. For example, the camera 302a sends object lists and images, the radar 302b sends object lists, and in-phase/quadrature (IQ) data, the LIDAR 302c sends object lists and scan points, the GPS 302d sends position and velocity, the IMU 302e sends acceleration data, and the V2X 302f controller sends tracks of other vehicles, turn signals, other sensor data, or traffic light data. A person of ordinary skill in the art can recognize that the sensor array 302 can employ other types of sensors, however. The SIC 304 monitors and diagnoses faults at each of the sensors 302a-f. In addition, the SIC 304 isolates the data from each sensor from its vendor specific package and sends vendor neutral data types to the perception controller (PC) 306 and localization controller 308 (LC). The SIC 304 forwards localization feature measurements and position and attitude measurements to the LC 308, and forwards tracked object measurements, driving surface measurements, and position & attitude measurements to the PC 306. The SIC 304 can further be updated with firmware so that new sensors having different formats can be used with the same modular architecture.

The LC 308 fuses GPS and IMU data with Radar, Lidar, and Vision data to determine a vehicle location, velocity, and attitude with more precision than GPS can provide alone. The LC 308 then reports that robustly determined location, velocity, and attitude to the PC 306. The LC 308 further monitors measurements representing position, velocity, and attitude data for accuracy relative to each other, such that if one sensor measurement fails or becomes degraded, such as a GPS signal in a city, the LC 308 can correct for it. The PC 306 identifies and locates objects around the vehicle based on the sensed information. The PC 306 further estimates drivable surface regions surrounding the vehicle, and further estimates other surfaces such as road shoulders or drivable terrain in the case of an emergency. The PC 306 further provides a stochastic prediction of future locations of objects. The PC 306 further stores a history of objects and drivable surfaces.

The PC 306 outputs two predictions, a strategic prediction, and a tactical prediction. The tactical prediction represents the world around 2-4 seconds into the future, which only predicts the nearest traffic and road to the vehicle. This prediction includes a free space harbor on shoulder of the road or other location. This tactical prediction is based entirely on measurements from sensors on the vehicle of nearest traffic and road conditions.

The strategic prediction is a long term prediction that predicts areas of the car's visible environment beyond the visible range of the sensors. This prediction is for greater than four seconds into the future, but has a higher uncertainty than the tactical prediction because objects (e.g., cars and people) may change their currently observed behavior in an unanticipated manner. Such a prediction can also be based on sensor measurements from external sources including other autonomous vehicles, manual vehicles with a sensor system and sensor communication network, sensors positioned near or on the roadway or received over a network from transponders on the objects, and traffic lights, signs, or other signals configured to communicate wirelessly with the autonomous vehicle.

FIG. 4 is a block diagram 400 illustrating an example embodiment of the automatic driving controller (ADC) 402, vehicle controller (VC) 404 and actuator controller 410. The ADC 402 and VC 404 execute the “decide” virtual layer of the CODA model.

The ADC 402, based on destination input by the operator and current position, first creates an overall route from the current position to the destination including a list of roads and junctions between roads in order to reach the destination. This strategic route plan may be based on traffic conditions, and can change based on updating traffic conditions, however such changes are generally enforced for large changes in estimated time of arrival (ETA). Next, the ADC 402 plans a safe, collision-free, corridor for the autonomous vehicle to drive through based on the surrounding objects and permissible drivable surface—both supplied by the PC. This corridor is continuously sent as a request to the VC 404 and is updated as traffic and other conditions change. The VC 404 receives the updates to the corridor in real time. The ADC 402 receives back from the VC 404 the current actual trajectory of the vehicle, which is also used to modify the next planned update to the driving corridor request.

The ADC 402 generates a strategic corridor for the vehicle to navigate. The ADC 402 generates the corridor based on predictions of the free space on the road in the strategic/tactical prediction. The ADC 402 further receives the vehicle position information and vehicle attitude information from the perception controller of FIG. 3. The VC 404 further provides the ADC 402 with an actual trajectory of the vehicle from the vehicle's actuator control 410. Based on this information, the ADC 402 calculates feasible corridors to drive the road, or any drivable surface. In the example of being on an empty road, the corridor may follow the lane ahead of the car.

In another example of the car needing to pass out a car, the ADC 402 can determine whether there is free space in a passing lane and in front of the car to safely execute the pass. The ADC 402 can automatically calculate based on (a) the current distance to the car to be passed, (b) amount of drivable road space available in the passing lane, (c) amount of free space in front of the car to be passed, (d) speed of the vehicle to be passed, (e) current speed of the autonomous vehicle, and (f) known acceleration of the autonomous vehicle, a corridor for the vehicle to travel through to execute the pass maneuver.

In another example, the ADC 402 can determine a corridor to switch lanes when approaching a highway exit. In addition to all of the above factors, the ADC 402 monitors the planned route to the destination and, upon approaching a junction, calculates the best corridor to safely and legally continue on the planned route.

The ADC 402 the provides the requested corridor 406 to the VC 404, which works in tandem with the ADC 402 to allow the vehicle to navigate the corridor. The requested corridor 406 places geometric and velocity constraints on any planned trajectories for a number of seconds into the future. The VC 404 determines a trajectory to maneuver within the corridor 406. The VC 404 bases its maneuvering decisions from the tactical/maneuvering prediction received from the perception controller and the position of the vehicle and the attitude of the vehicle. As described previously, the tactical/maneuvering prediction is for a shorter time period, but has less uncertainty. Therefore, for lower-level maneuvering and safety calculations, the VC 404 effectively uses the tactical/maneuvering prediction to plan collision-free trajectories within requested corridor 406. As needed in emergency situations, the VC 404 plans trajectories outside the corridor 406 to avoid collisions with other objects.

The VC 404 then determines, based on the requested corridor 406, the current velocity and acceleration of the car, and the nearest objects, how to drive the car through that corridor 406 while avoiding collisions with objects and remain on the drivable surface. The VC 404 calculates a tactical trajectory within the corridor, which allows the vehicle to maintain a safe separation between objects. The tactical trajectory also includes a backup safe harbor trajectory in the case of an emergency, such as a vehicle unexpectedly decelerating or stopping, or another vehicle swerving in front of the autonomous vehicle.

As necessary to avoid collisions, the VC 404 may be required to command a maneuver suddenly outside of the requested corridor from the ADC 402. This emergency maneuver can be initiated entirely by the VC 404 as it has faster response times than the ADC 402 to imminent collision threats. This capability isolates the safety critical collision avoidance responsibility within the VC 404. The VC 404 sends maneuvering commands to the actuators that control steering, throttling, and braking of the vehicle platform.

The VC 404 executes its maneuvering strategy by sending a current vehicle trajectory 408 having driving commands (e.g., steering, throttle, braking) to the vehicle's actuator controls 410. The vehicle's actuator controls 410 apply the commands to the car's respective steering, throttle, and braking systems. The VC 404 sending the trajectory 408 to the actuator controls represent the “Act” virtual layer of the OODA model. By conceptualizing the autonomous vehicle architecture in this way, the VC is the only component needing configuration to control a specific model of car (e.g., format of each command, acceleration performance, turning performance, and braking performance), whereas the ADC remaining highly agnostic to the specific vehicle capacities. In an example, the VC 404 can be updated with firmware configured to allow interfacing with particular vehicle's actuator control systems, or a fleet-wide firmware update for all vehicles.

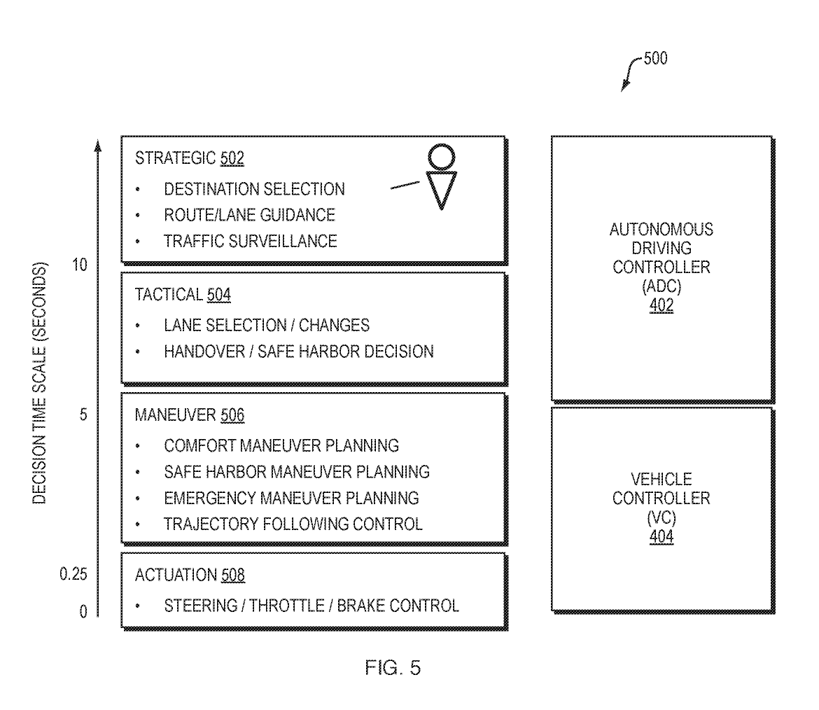

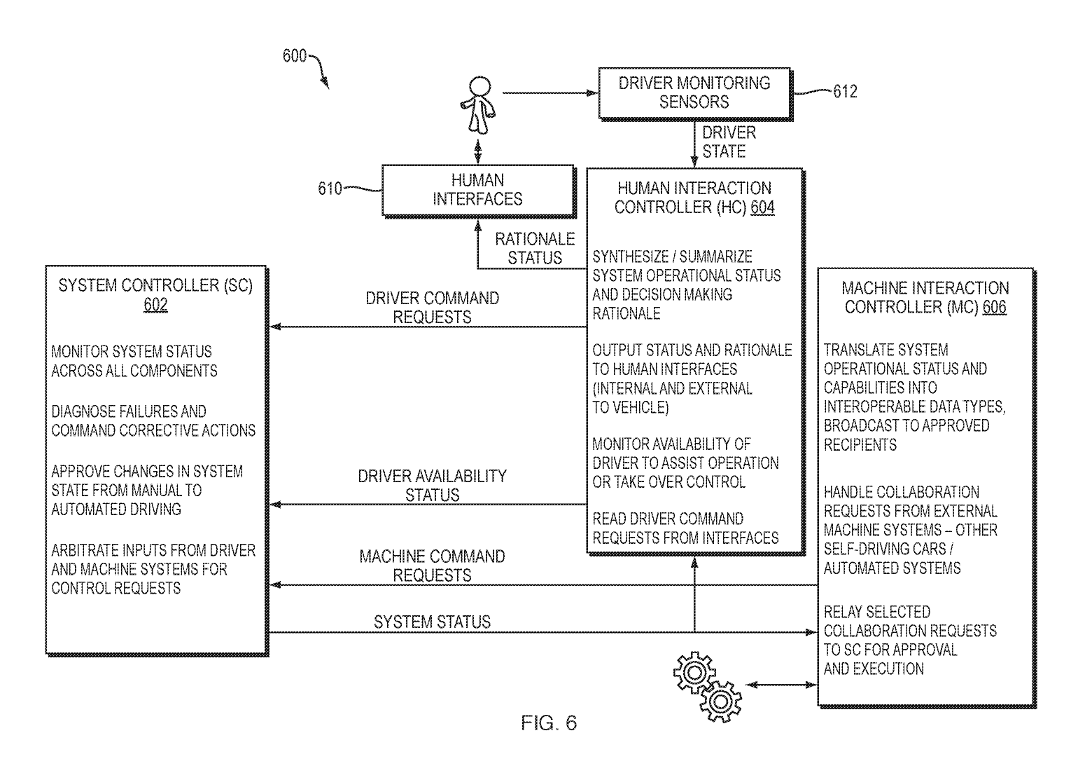

FIG. 5 is a diagram 500 illustrating decision time scales of the ADC 402 and VC 404. The ADC 402 implements higher-level, strategic 502 and tactical 504 decisions by generating the corridor. The ADC 402 therefore implements the decisions having a longer range/or time scale. The estimate of world state used by the ADC 402 for planning strategic routes and tactical driving corridors for behaviors such as passing or making turns has higher uncertainty, but predicts longer into the future, which is necessary for planning these autonomous actions. The strategic predictions have high uncertainty because they predict beyond the sensor's visible range, relying solely on non-vision technologies, such as Radar, for predictions of objects far away from the car, that events can change quickly due to, for example, a human suddenly changing his or her behavior, or the lack of visibility of objects beyond the visible range of the sensors. Many tactical decisions, such as passing a car at highway speed, require perception Beyond the Visible Range (BVR) of an autonomous vehicle (e.g., 100 m or greater), whereas all maneuverability 506 decisions are made based on locally perceived objects to avoid collisions.

The VC 404, on the other hand, generates maneuverability decisions 506 using maneuverability predictions that are short time frame/range predictions of object behaviors and the driving surface. These maneuverability predictions have a lower uncertainty because of the shorter time scale of the predictions, however, they rely solely on measurements taken within visible range of the sensors on the autonomous vehicle. Therefore, the VC 404 uses these maneuverability predictions (or estimates) of the state of the environment immediately around the car for fast response planning of collision-free trajectories for the autonomous vehicle. The VC 402 issues actuation commands, on the lowest end of the time scale, representing the execution of the already planned corridor and maneuvering through the corridor.

FIG. 6 is a block diagram 600 illustrating an example embodiment of the system controller 602, human interface controller 604 (HC) and machine interface controller 606 (MC). The human interaction controller 604 (HC) receives input command requests from the operator. The HC 604 also provides outputs to the operator, passengers of the vehicle, and humans external to the autonomous vehicle. The HC 604 provides the operator and passengers (via visual, audio, haptic, or other interfaces) a human-understandable representation of the system status and rationale of the decision making of the autonomous vehicle. For example, the HC 604 can display the vehicle's long-term route, or planned corridor and safe harbor areas. Additionally, the HC 604 reads sensor measurements about the state of the driver, allowing the HC 604 to monitor the availability of the driver to assist with operations of the car at any time. As one example, a sensor system within the vehicle could sense whether the operator has hands on the steering wheel. If so, the HC 604 can signal that a transition to operator steering can be allowed, but otherwise, the HC 604 can prevent a turnover of steering controls to the operator. In another example, the HC 604 can synthesize and summarize decision making rationale to the operator, such as reasons why it selected a particular route. As another example, a sensor system within the vehicle can monitor the direction the driver is looking. The HC 604 can signal that a transition to driver operation is allowed if the driver is looking at the road, but if the driver is looking elsewhere, the system does not allow operator control. In a further embodiment, the HC 604 can take over control, or emergency only control, of the vehicle while the operator checks the vehicle's blind spot and looks away from the windshield.

The machine interaction controller 606 (MC) interacts with other autonomous vehicles or automated system to coordinate activities such as formation driving or traffic management. The MC 606 reads the internal system status and generates an output data type that can be read by collaborating machine systems, such as the V2X data type. This status can be broadcast over a network by collaborating systems. The MC 606 can translate any command requests from external machine systems (e.g., slow down, change route, merge request, traffic signal status) into commands requests routed to the SC for arbitration against the other command requests from the HC 604. The MC 606 can further authenticate (e.g., using signed messages from other trusted manufacturers) messages from other systems to ensure that they are valid and represent the environment around the car. Such an authentication can prevent tampering from hostile actors.

The system controller 602 (SC) serves as an overall manager of the elements within the architecture. The SC 602 aggregates the status data from all of the system elements to determine total operational status, and sends commands to the elements to execute system functions. If elements of the system report failures, the SC 602 initiates diagnostic and recovery behaviors to ensure autonomous operation such that the vehicle remains safe. Any transitions of the vehicle to/from an automated state of driving are approved or denied by the SC 602 pending the internal evaluation of operational readiness for automated driving and the availability of the human driver.

In most cases, a self-driving car needs to know the location of itself relative to the Earth. While GPS systems that are available in many cars and cellular phones today provide a location, that location is not precise enough to determine which lane on a highway a car travels in, for example. Another problem with relying solely on GPS systems to determine a location of the self-driving car relative to the Earth is that GPS can fail, for example, within tunnels or within urban canyons in cities.

In an embodiment of the present invention, a localization module can provide coordinates of the vehicle relative to the Earth and relative to the road, both of which are precise enough to allow for self-driving, and further can compensate for a temporary lapse in reliable GPS service by continuing to track the car's position by tracking its movement with inertial sensors (e.g., accelerometers and gyroscopes), camera data and RADAR data. In other words, the localization module bases its output on a geolocation relative to the Earth and sensor measurements of the road and its surroundings to determine where the car is in relation to the Earth and the road.

The localization module fuses outputs from a set of complimentary sensors to maintain accurate car localization during all operating conditions. The accurate car localization includes a calculated (a) vehicle position and (b) vehicle attitude. Vehicle position is a position of the vehicle relative to earth, and therefore also relative to the road. Vehicle attitude is an orientation of the vehicle, in other words, which direction the vehicle is facing. The localization is calculated from the combination of a GPS signal, inertial sensors, and locally observed and tracked features from vision and radar sensors. The tracked features can be either known visual landmark features from a database (e.g., Google Street View) or unknown opportunistically sensed features (e.g., a guard rail on the side of the road). Sensed data is filtered so that such features are analyzed for localization if they are stationary relative to the ground.

GPS devices and GPS applications rely on civilian, coarse/acquisition (C/A) GPS code, which can be accurate to approximately 3.5 meters in ideal conditions. For example, a common occurrence with typical GPS applications and devices is that the GPS cannot determine which of two closely parallel streets the vehicle is on. To automate a self-driving car, however, greater accuracy is needed.

No known systems employ radar-based feature tracking with Doppler velocity as an additional aid to determine local position of a car relative to the road or relative to the Earth. Therefore, one novel aspect of embodiments of the present invention is employing tracked objects in smart radar data having feature tracks and Doppler velocity as an aid to an inertial navigation system for dead reckoning or place recognition. In addition to Radar, the system can also use other forms of data, such as inertial data from an inertial measurement unit, vision systems, and vehicle data.

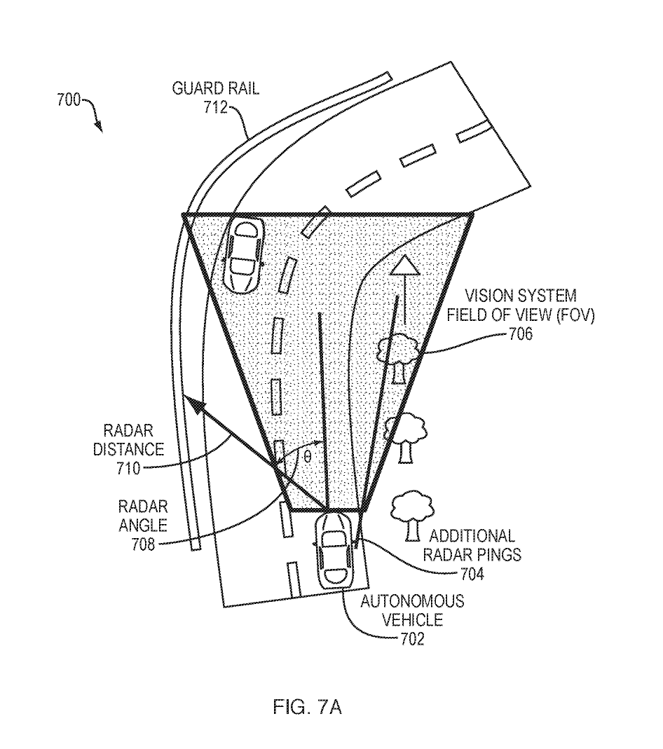

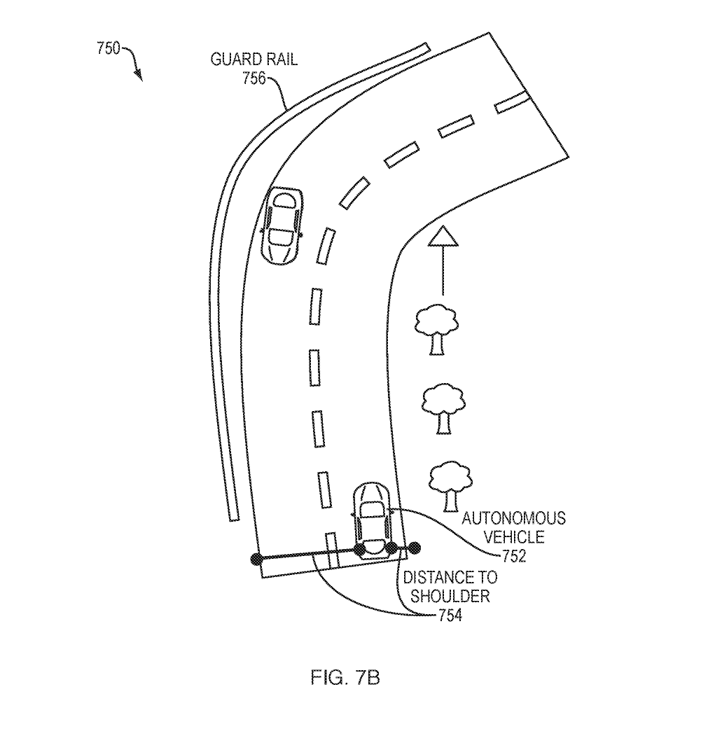

FIGS. 7A-B are diagrams illustrating an embodiment of the present invention in a real-world environment. FIG. 7A illustrates a self-driving car driving along a curved road. The self-driving car's vision systems detect certain features in its field of view, such as the other car, the trees, road sign, and guard rail on the road's embankments. Further, the self-driving car's RADAR systems detect nearby features, such as the other car, guard rail, sign-posts, landmark features, buildings, dunes or hills, orange safety cones or barrels, or pedestrians, or any other feature representing objects. As an example, the RADAR data to the other guard rail includes a detected distance as well as a detected angle, θ. A person of ordinary skill in the art can further recognize that the vision sensor may detect features that the RADAR does not detect, such size or color of features, while the RADAR can reliably detect features and their respective distances, and angles from the car, inside and outside of the FOV of the vision systems.

FIG. 7B illustrates an example embodiment of data directly extrapolated from the vision and RADAR systems. The system can determine the distance from the shoulder to the road on both sides of the car. Correlated with robust map information including the width of the roads and locations of lanes in each road, the system can then determine exactly where the car is relative to the earth.

In an embodiment of the present invention, a localization controller, which can also be called a localization module, can supplement GPS data with information from other sensors including inertial sensors, vision sensors and RADAR to provide a more accurate location of the car. For example, given a GPS signal, a vision sensor or a radar sensor can determine a car's location relative to the side of the road. A vision sensor can visually detect the edge of the road by using edge detection or other image processing methods, such as determining features, like trees or guardrails, on the side of the road. A RADAR sensor can detect the edge of the road by detecting features such as road medians, or other stationary features like guard rails, sign posts, landmark features, buildings, dunes or hills, orange safety cones or barrels, or pedestrians, and determining the distance and angle to those stationary features. The RADAR reading of each feature carries the distance of the feature in addition to the angle of the feature. RADAR readings over multiple time steps can further increase the determination of the accuracy of the car's location by reducing the possible noise or error in one RADAR reading.

From this information, an embodiment of the localization module can determine a distance to the side of the road on each side of the car. This information, determined by vision systems and RADAR, can be correlated with map data having lane locations and widths to determine that the car is driving in the proper lane, or able to merge off a highway on an off-ramp.

GPS devices can also be unreliable in urban canyons, tunnels, or may fail due to other reasons. In an embodiment of the present invention, the localization module can perform dead reckoning of determining an Earth location without accurate GPS data by combining inertial data of the car from an Inertial Measurement Unit (IMU) (e.g., accelerometer and gyroscope data, wheel spin rate, turn angle of the wheels, odometer readings, or other information) with RADAR data points to track the car while the GPS device has stopped providing reliable GPS data. The localization module, combining this data, tracks the position and velocity of the car relative to its previous position to estimate a precise global position of the car. Other dead reckoning strategies include determining (a) distinctive lane markings, and (b) mile markers.

In another embodiment, map matching can compare the shape of a corridor navigated by the vehicle to a map, which is called map matching. For example, the trajectory of a car's movement within a tunnel can match map data. Each tunnel may have a shape or signature that can be identified by certain trajectories, and allow the vehicle to generate a position based on this match.

In sum, the localization module determines where the vehicle is relative to (a) the road and (b) the world by using data from its IMU, vision and RADAR systems and a GPS starting location.

In another embodiment, the present invention can determine a car's location using place recognition/landmark matching. A vision sensor outputs photographic data of a location and compares the data to a known database of street-level image repository, such as Google Street View to determine a geodetic location, for example, determined by a GPS system. The landmark matching process can (a) recognize the landmark to determine a location. For example, the landmark may be the Empire State Building, and the system then determines the vehicle is in New York City. To gain further precision, landmark recognition can determine, from the size of the photo and the angle towards the landmark, a distance and angle from the landmark in reality. RADAR can further accomplish the same goal, by associating a RADAR feature with the image, and learning its distance and angle from the vehicle from the RADAR system.

The localization module outputs a location of the vehicle with respect to Earth. The localization module uses GPS signals whenever available. If the GPS signal is unavailable or unreliable, the localization module tries to maintain an accurate location of the vehicle using IMU data and RADAR. If the GPS signal is available, the localization module provides a more precise and robust geodetic location. In further embodiments, vision sensors can be employed.

Other parallel systems perform different, but similar, functions as the localization module. For example, a perception module uses vision sensors to determine lane markings and derive lane corridors from those markings. However, while that information is helpful to navigate a self-driving car, the localization module can determine which lane to drive in when lane markings are obscured (e.g., covered by snow or other objects, or are not present on the road) and maintain global position during GPS failure. In sum, the localization module improves GPS by providing a more precise location, a location relative to the road, and further providing a direction of the vehicle's movement based on RADAR measurements at different time steps.

RADAR is employed in embodiments of the present invention by first gathering an list of features in its field of view (FOV). From the features returned from the sensor, the localization module filters out moving features, leaving only stationary features that are fixed to the earth in the remaining list. The localization module tracks the stationary or fixed features at each time step. The localization module can triangulate a position for each feature by processing the RADAR data for each feature, which includes the angle to the feature and the distance from the feature. Some vision systems cannot provide the appropriate data for triangulation because they do not have the capability to determine range. Generally, this reduces any margin of error or inaccuracies from the IMU, and provides a more precise location of where the car is relative to the Earth, and in the specific situation of dead reckoning, can figure out where the car is without an up-to-date GPS signal.

While RADAR may be used in certain embodiments without IMU data, the IMU provides a higher data rate than RADAR alone. Therefore, the localization module advantageously combines IMU data with RADAR data by correcting the faster IMU data with the slower RADAR data as RADAR data is received.

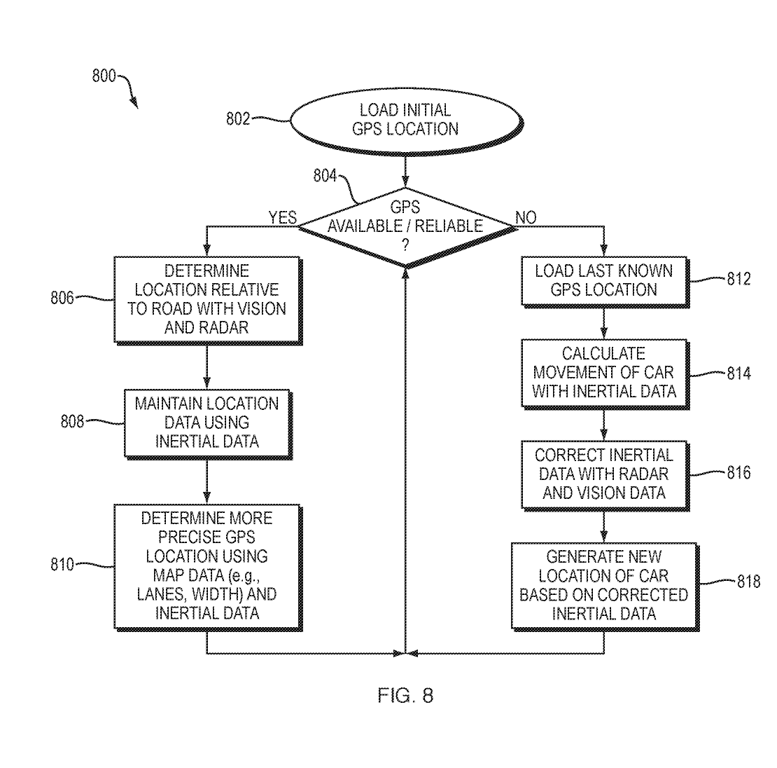

FIG. 8 is a flow diagram illustrating an example embodiment of a process employed by the present invention. After loading an initial GPS location, the process continually determines whether GPS is available or reliable. If so, the process determines a location of the car relative to the road with vision systems and RADAR. The system maintains location data between GPS updates using inertial data. Finally, the system determines a more precise geodetic location relative to the earth, using the map data and inertial data to fine tune the initial GPS signal.

If there is no reliable GPS signal, the process begins using the last known GPS location. The process calculates movement of the car with inertial data, and then corrects the inertial data (e.g., for drift, etc.) with RADAR and vision data. The process then generates a new location of the car based on the corrected inertial data, and repeats until the GPS signal becomes available again.

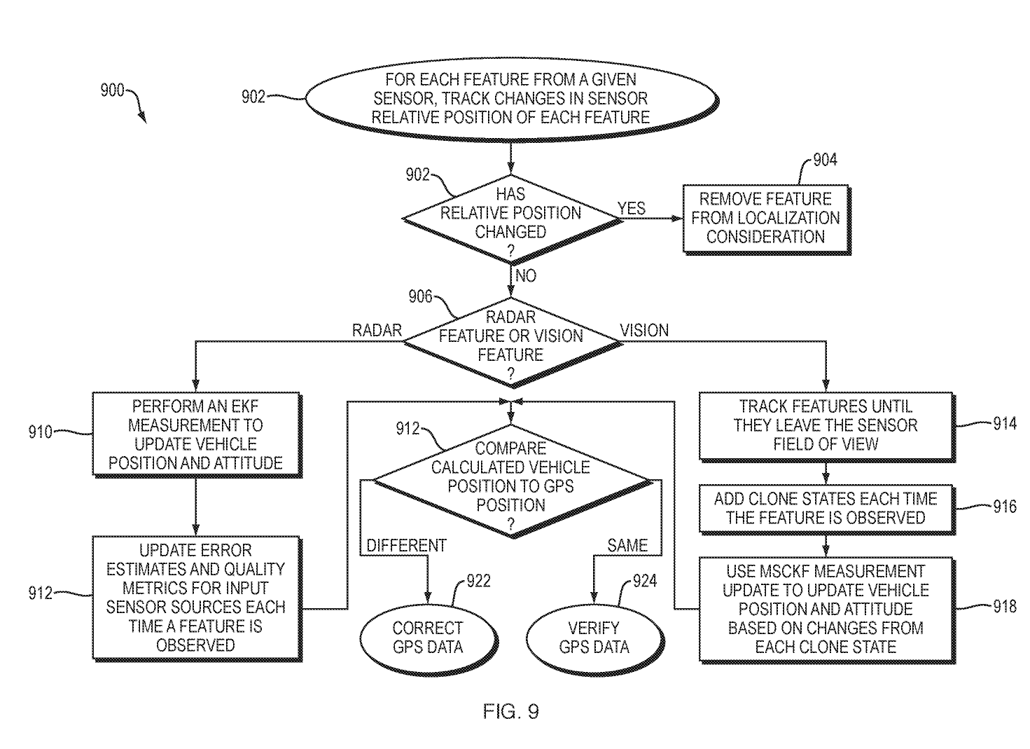

FIG. 9 is a flow diagram 900 illustrating a process employed by the present invention. A hybrid Extended Kalman Filter (EKF)/Multi-State-Constrained-Kalman-Filter (MSCKF) filter is used to estimate statistically optimal localization states from all available sensors. For each feature from a given sensor (e.g., radar, vision, lidar), the process tracks changes in sensor relative position of each feature (902). If the feature is observed as moving, by the sensor reporting a velocity, or having two readings of the same feature be at different locations, the system determines the relative position has changed (902) and removes that feature from localization consideration (904). Features that are deemed to be moving should not be considered in localization calculations, because localization uses only features that are stationary in the local environment to verify the vehicle's world location.

For vision features (906), the method tracks features until they leave the sensor field of view (914), and adds clone states (a snapshot of the current estimated vehicle position, velocity and attitude) each time the feature is observed (916). The clone states are used to determine the difference in relative location from the visual feature's previous observation. With the exception of 3D vision systems, visual features do not include range information, and therefore clone states are needed with 2D vision systems to calculate the range of each feature. Once the visual feature is no longer viewable, the method performs an MSCKF measurement update to update vehicle position and attitude for each clone state, and further updates error estimates and quality metrics for input sensor sources (918).

For radar features (906), the method performs an EKF measurement to update vehicle position and attitude (910). The method then updates error estimates and quality metrics for input sensor sources each time a feature is observed (912). The method does not need to clone features to determine their relative change. There is no need for clone states since radar can directly measure range.

The method them compares the calculated vehicle position (e.g., results of 912, 918), to the position from the GPS signal (920). If it is the same, the method verifies GPS data (924). If it is different, the method corrects GPS data (922) based on the movement of the car relative to the stationary features. In other embodiments, instead of correcting the GPS data, the information is used to supplement the GPS data.

In embodiments of the present invention, smart radar sensors aid localization. Smart radar sensors output, from one system, radar data and multi-target tracking data.

In embodiments, radar can track terrain features. While radar is most effective detecting metal, high frequency radar can track non-metal objects as well as metal objects. Therefore, radar can provide a robust view of the objects around the car and terrain features, such as a dune or hill at the side of the road, safety cones or barrels, or pedestrians.

In embodiments, machine vision can track terrain features, such as a green grass field being a different color from the paved road. Further, the machine vision can track lane lines, breakdown lanes, and other color-based information that radar is unable to detect.

In embodiments, history of radar feature locations in the sensor field of view is employed along with each feature's range data. The history of radar features can be converted to relative positions of each feature with respect to automobile, which can be used to localize the vehicle relative to a previous known position.

In embodiments, history of vision feature locations in sensor field of view can also be employed by converting relative lines of sight with respect to the automobile. Each line of sight to a feature can be associated with an angle from the vehicle and sensor. Multiple sensors can further triangulate the distance of each feature at each time step. Therefore, the feature being tracked across multiple time steps can be converted to a relative position by determining how the angle to each feature changes at each time step.

In another embodiment, the method combines radar feature history, vision feature history, IMU sensor data, GPS (if available), and vehicle data (e.g., IMU data such as steering data, wheel odometry) to update location and attitude of vehicle is updated using a hybrid Extended Kalman Filter (EKF) and a multi-state-constrained Kalman filter (MSCKF), as described above. A person of ordinary skill in the art can note that the same methods as described above can be used to combine other sources of data, such as IMU sensor data, to supplement GPS information by calculating relative position changes of the vehicle with local data.

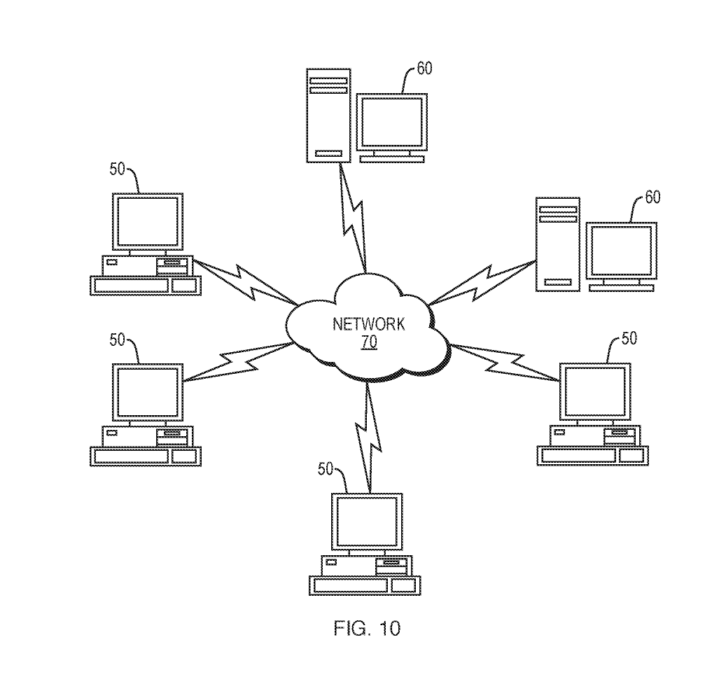

FIG. 10 illustrates a computer network or similar digital processing environment in which embodiments of the present invention may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

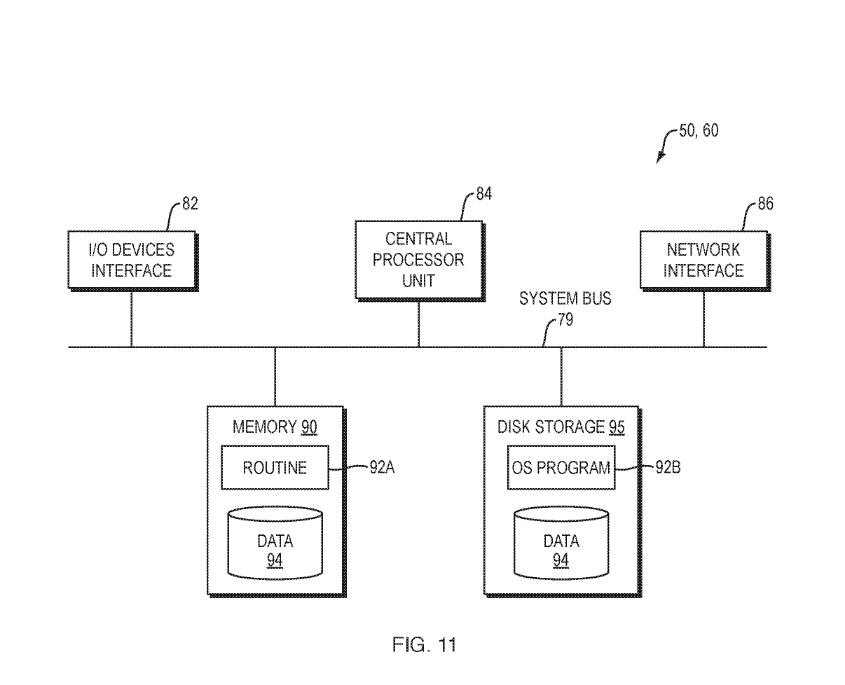

FIG. 11 is a diagram of an example internal structure of a computer (e.g., client processor/device 50 or server computers 60) in the computer system of FIG. 10. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 10). Memory 90 provides volatile storage for computer software instructions 92 and data 94 used to implement an embodiment of the present invention (e.g., sensor interface controller, perception controller, localization controller, automated driving controller, vehicle controller, system controller, human interaction controller, and machine interaction controller detailed above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92.

While this invention has been particularly shown and described with references to example embodiments thereof, it will be understood by those skilled in the art that various changes in form and details may be made therein without departing from the scope of the invention encompassed by the appended claims.

What is claimed is:

1. A method of navigating an autonomous vehicle, the method comprising:
correlating a global positioning system (GPS) signal received at an autonomous vehicle with a position on a map loaded from a database;
determining, from a list of features received from a RADAR sensor of the autonomous vehicle over a plurality of time steps relative to the autonomous vehicle, a location of the autonomous vehicle relative to the drivable surface; and
providing an improved location of the autonomous vehicle based on the location of the autonomous vehicle relative to the drivable surface and the GPS signal by correlating the location of the autonomous vehicle relative to the drivable surface to lane data and drivable surface width from a map.

2. The method of claim 1, further comprising determining, from the list of features, an attitude of the autonomous vehicle relative to the drivable surface.

3. The method of claim 1, further comprising matching image data received by a vision sensor of the autonomous vehicle to landmark features stored in a database.

4. The method of claim 1, further comprising:
tracking relative position of each feature from a given sensor across multiple time steps; and
retaining features determined to be stationary based on the tracked relative position.

5. The method of claim 4, further comprising:
for radar features, performing an Extended Kalman Filter (EKF) measurement to update vehicle position and attitude, and updating error estimates and quality metrics for input sensor sources, each time a radar feature is observed;

6. The method of claim 4, further comprising:
for vision features:
tracking each vision feature until each vision feature leaves a sensor field of view;
adding clone states each time the feature is observed; and
upon the vision feature leaving a field-of-view of the sensor, performing a Multi-State-Constrained-Kalman-Filter (MSCKF) filter measurement update to update vehicle position and attitude, and update error estimates and quality metrics for input sensor sources.

7. The method of claim 4, wherein retaining features includes employing both radar features tracks and vision feature tracks, and determining stationary features based on a comparison of predicted autonomous vehicle motion to the feature tracks.

8. The method of claim 1, wherein the RADAR sensor outputs RADAR features and multi-target tracking data.

9. The method of claim 1, further comprising converting the list of features to a list of relative positions of objects relative to the position of the autonomous vehicle.

10. The method of claim 1, wherein the features are vision features, and further comprising:
converting the vision features to lines of sight relative to the autonomous vehicle.

11. The method of claim 1, further comprising providing an improved location further includes employing inertial measurement unit (IMU) data.

12. A system for navigating an autonomous vehicle, the system comprising:
a correlation module configured to correlate a global positioning system (GPS) signal received at an autonomous vehicle with a position on a map loaded from a database;
an localization controller configured to:
determine, from a list of features received from a RADAR sensor of the autonomous vehicle over a plurality of time steps relative to the autonomous vehicle, a location of the autonomous vehicle relative to stationary features in the environment; and
provide an improved location of the autonomous vehicle based on the location of the autonomous vehicle relative to the drivable surface and the GPS signal by correlating the location of the autonomous vehicle relative to the drivable surface to lane data and drivable surface width from a map.

13. The system of claim 12, wherein the localization controller is further configured to determine, from the list of features, an attitude of the autonomous vehicle relative to the drivable surface.

14. The system of claim 12, wherein the localization controller is further configured to match image data received by a vision sensor of the autonomous vehicle to landmark features stored in a database.

15. The system of claim 12, wherein the localization controller is further configured to:
track relative position of each feature from a given sensor across multiple time steps; and
retain features determined to be stationary based on the tracked relative position.

16. The system of claim 15, wherein the localization controller is further configured to, for radar features, perform an Extended Kalman Filter (EKF) measurement to update vehicle position and attitude, and update error estimates and quality metrics for input sensor sources, each time a radar feature is observed, and further comprising:
evaluating the quality of the a GPS signal so that subsequent localization functions know the expected position quality;
determining a last known accurate GPS solution based on the quality metrics.

17. The system of claim 15, wherein the localization controller is further configured to, for vision features:
track each vision feature until each vision feature leaves a sensor field of view;
add clone states each time the feature is observed; and
upon the vision feature leaving a field-of-view of the sensor, perform a Multi-State-Constrained-Kalman-Filter (MSCKF) filter measurement update to update vehicle position and attitude, and update error estimates and quality metrics for input sensor sources.

18. The system of claim 15, wherein the localization controller is further configured to retain features by employing both radar features tracks and vision feature tracks, and determining stationary features based on a comparison of predicted autonomous vehicle motion to the feature tracks.

19. The system of claim 12, wherein the RADAR sensor outputs RADAR features and multi-target tracking data.

20. The system of claim 12, wherein the localization controller is further configured to convert the list of features to a list of relative positions of features relative to the position of the autonomous vehicle.

21. The system of claim 12, wherein the features are vision features, and wherein the localization controller is further configured to convert the vision features to lines of sight relative to the autonomous vehicle.

22. The system of claim 12, wherein the localization controller is further configured to provide an improved location further includes employing inertial measurement unit (IMU) data.

23. A method of navigating an autonomous vehicle, the method comprising:
determining a last accurate global positioning system (GPS) signal received at an autonomous vehicle;
determining a trajectory of the autonomous vehicle based on data from an inertial measurement unit (IMU) of the autonomous vehicle and RADAR data including a list of stationary features over a plurality of time steps relative to the autonomous vehicle, the list of stationary features having a distance and angle of each stationary feature relative to the autonomous vehicle; and
calculating a new position of the autonomous vehicle by combining the last accurate GPS signal with the trajectory.

24. A system for navigating an autonomous vehicle, the system comprising:
a GPS receiver of an autonomous vehicle; and
a localization module configured to:
determine a last accurate global positioning system (GPS) signal received at the GPS receiver of the autonomous vehicle;
determine a trajectory of the autonomous vehicle based on data from an inertial measurement unit (IMU) of the autonomous vehicle and RADAR data including a list of stationary features over a plurality of time steps relative to the autonomous vehicle, the list of stationary features having a distance and angle of each stationary feature relative to the autonomous vehicle; and
calculate a new position of the autonomous vehicle by combining the last accurate GPS signal with the trajectory.
